(19) United States
(12) Patent Application Publication
(10) Pub. No.: US 2010/0014792 A1
(43) Pub. Date: Jan. 21, 2010

(54) AUTOMOTIVE STRUT RING BEARING ASSEMBLY WITH SPRING SEAT AND INTEGRAL DAMPENING MEMBER

(75) Inventor: David M. Kellam, Stratford (CA)

Correspondence Address: JAMES D. STEVENS;REISING ETHINGTON P.C., P.O. BOX 4390, TROY, MI, 48099, US

(73) Assignee: SCHAEFFLER KG, Herzogenaurach (DE)

(21) Appl. No.: 12/174,659

(22) Filed: Jul. 17, 2008

(51) Int. Cl. F16C 23/08

(52) U.S. Cl. 384/196

(57) ABSTRACT

A ring bearing assembly for an automotive suspension strut assembly. The ring bearing assembly includes an annular bearing having a lower housing member that functions as an integral spring seat for the suspension's coil spring. An isolator is molded to the spring seat as an integral component with a groove or other mechanical retention feature being used to help maintain the isolator in place and prevent it from working itself out of position over time during vehicle use.

### TECHNICAL FIELD

This invention relates generally to automotive suspension struts and, more particularly, to arrangements for seating a suspension spring against a ring bearing at the upper end of the strut.

### BACKGROUND OF THE INVENTION

A typical automotive suspension strut assembly includes a suspension spring and shock absorber supported at their bottom end by an associated wheel and engaged with the vehicle chassis at their upper end so as to suspend the vehicle chassis over the wheel. The chassis can be supported on the suspension spring by way of an annular bearing with a spring seat disposed underneath the bearing to receive the suspension spring. To reduce the transmission of vibration and noise through the spring to the chassis, a rubber isolator is typically added at the surface of the spring seat so that the suspension spring directly engages the isolator rather than the spring seat itself.

The rubber isolators commonly used are a separate component assembled in place by hand as a part of the overall strut assembly process. Typically, the isolator is held in place due to a portion of the weight of the vehicle being applied through the bearing and spring seat which presses the isolator against the spring. Being a separate component, vibrations arising from use of the vehicle can travel up the strut assembly causing the isolator to roll out or otherwise work itself out of position. Thus, there is a need for a spring seat and isolator arrangement for suspension strut assemblies that can provide better retention of the isolator in place while simplifying assembly of the strut assembly itself.

### SUMMARY OF THE INVENTION

In accordance with one aspect of the invention, there is provided a ring bearing assembly for use with a suspension spring in an automotive suspension strut. The bearing assembly includes a bearing, spring seat, and isolator that is positioned within the spring seat such that it fits between the spring seat and a suspension spring of the vehicle. The spring seat has an exterior surface having a mechanical retention feature. The isolator has an interior surface in contact with the exterior surface of said spring seat, and the isolator includes a complementary retention feature at its interior surface that mates with the mechanical retention feature to thereby help maintain the isolator in position in the spring seat.

In accordance with another aspect of the invention, there is provided a ring bearing assembly that includes a bearing, spring seat, and an isolator molded in place against the spring seat such that the isolator is permanently bonded to the spring seat. This bond can be achieved in various ways, such as by a suitable selection of materials and molding process. In one embodiment, glass-filled nylon is used for the spring seat and a TPE or MPE thermoplastic is used for the isolator with the isolator either being overmolded to the spring seat or co-molded with the spring seat by injection molding. Retention features can optionally be used in combination with the molded bond to provide a dual means of retaining the isolator to the spring seat.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is fragmentary, cross-sectional view of a first embodiment of a ring bearing assembly used at an upper end of an automotive strut;

FIG. 2 is a fragmentary, cross-sectional view as in FIG. 1 showing a second embodiment of a ring bearing assembly; and

FIG. 3 is a fragmentary, cross-sectional view as in FIG. 1 showing a third embodiment of a ring bearing assembly.

### DETAILED DESCRIPTION OF THE PREFERRED EMBODIMENTS

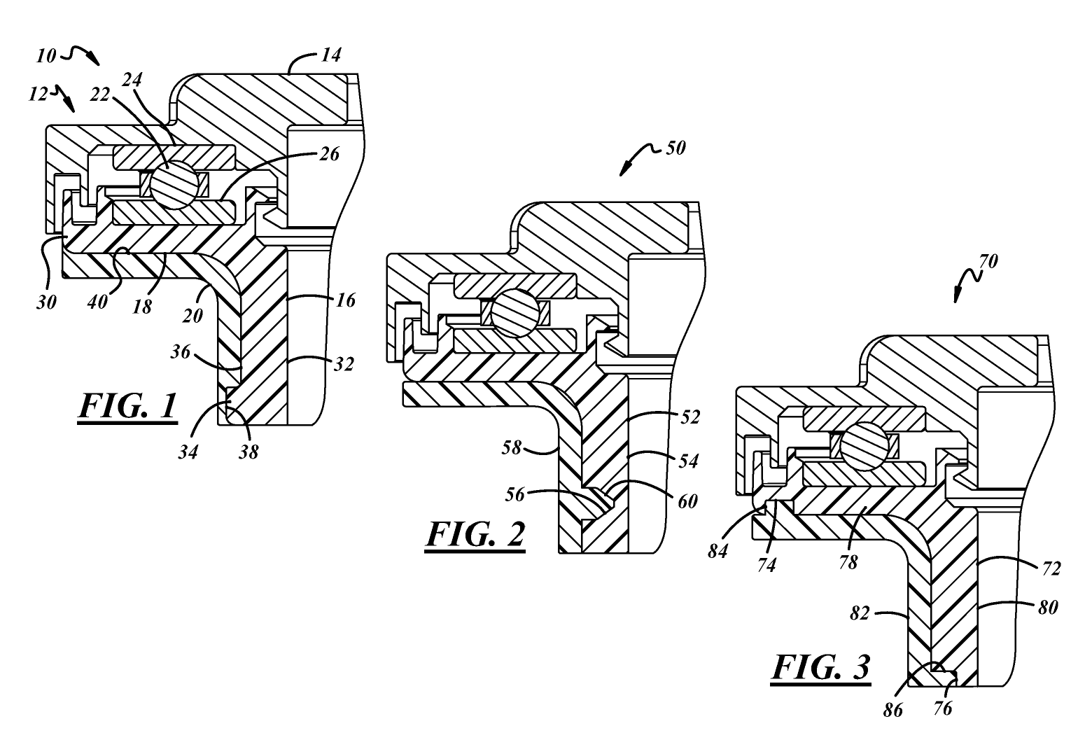

FIG. 1 depicts a first embodiment 10 of a ring bearing assembly such as can be used, for example, in an automotive McPherson strut assembly. The ring bearing assembly 10 generally includes a bearing 12 having an upper annular bearing member 14 and a lower annular bearing member 16 that defines a spring seat 18 having an integral isolator 20. The internal components of bearing 12 can be of a conventional design and can include, for example, a plurality of ball bearings 22 or other roller elements retained between a pair of facing bearing rings 24, 26 each fit within an annular channel of a respective one of the bearing members 14, 16. Thus, in the embodiment shown in FIG. 1, the facing surfaces of the bearing rings 24, 26 comprise confronting bearing surfaces that engage the ball bearings 22 as they roll due to relative rotational movement of the two bearing rings. As will be appreciated by those skilled in the art, other bearing designs can be used. For example, the separate bearing rings 24, 26 can be integrated into the upper and lower bearing members 14, 16 as single integrated components such that the bearing members themselves comprise the confronting bearing surfaces that engage the roller elements. In another embodiment, no roller elements need be used, but rather the bearing surfaces can directly contact each other, with a suitable low friction material, coating, or lubricant being used.

The lower bearing member 16 provides a dual function—it serves as a lower housing for the bearing and includes a unitary spring seat 18 that provides the bearing member 16 with a contour that is shaped and sized to receive a suspension coil spring (not shown). For this purpose, the lower bearing member 16 has both a radially-extending flange 30 and an axially-extending hub 32 located radially-inwardly of the flange. The junction of the flange 30 and hub 32 defines the integral spring seat 18 that accommodates the upper end of the suspension spring. To dampen vibrations transmitted by the coil spring, the spring seat 18 includes the integral isolator 20 that can be formed from any suitable resilient material. Conventional isolator materials such as rubber can be used; however, there are numerous other commercially available materials that provide suitable dampening and resilience for a typical vehicle application. For example, a thermoplastic elastomer (TPE), melt processible elastomer (MPE), or thermoplastic polyurethane (TPU) can be used, as will be discussed below in greater detail.

Isolator 20 can be made integral with the spring seat 18 using one or more means of attaching the two components together. In the embodiment shown in FIG. 1, at least two separate means are used together to form a permanent connection between the spring seat 18 and isolator 20. One means is the use of retention features on the two components which, as shown in FIG. 1, includes a radial protrusion 34 at an exterior surface 36 of the hub 32 and an associated annular recess or groove 38 formed into the interior surface 40 of the isolator. The radial protrusion 34 presents a lip against which rests a mating shoulder of the isolator at the recess 38. This lip acts as a mechanical retention feature with the shoulder being a complementary retention feature that engages the lip and helps maintain the isolator 20 fixed in position. The second means for maintaining the isolator in place results from molding the isolator in place against the spring seat so that it has a closely conforming fit that reduces the likelihood of separation of the two components. Various suitable molding techniques are describe further below. Additionally, depending on the material and possibly the molding process used, direct bonding of the two components can occur providing yet a third means of permanently connecting the components together.

Before describing the molding and bonding of the spring seat 18 and isolator 20, the alternative embodiments 50 and 70 of respective FIGS. 2 and 3 will be described. The components and construction of the embodiments 50, 70 that are not expressly described below can be the same as that described above in connection with FIG. 1. As shown in FIG. 2, the hub 54 of the spring seat 52 includes a mechanical retention feature in the form of an annular groove 56, whereas the isolator 58 includes a rib 60 shaped as a complementary retention feature that extends radially inwardly into the groove 56 to help lock the isolator in place. In this embodiment, the isolator can be formed as a separate component and then pressed onto the hub 54 so that the rib 60 snaps into the groove 56. In other embodiments, the isolator 58 can be molded in place as in FIG. 1. For FIG. 3, the mechanical retention feature of the spring seat 72 comprises a pair of grooves 74, 76, one of which is formed in an exterior surface of the its flange 78 and the other of which is formed in the exterior surface of its hub 80. The isolator 82 includes complementary annular ribs 84, 86 that fit within their respective groove 74, 76. Again the isolator 82 can be formed as a separate component that is later attached to the spring seat 72 or can be molded in place to the spring seat.

The annular bearing members 14, 16 (and, thus, spring seat 18) can be made from a nylon or other glass or fiber filled thermoplastic; for example, PA66.GF33, PA66.GF43, PA66.GF35, or PA66.GF25. Alternatively, other suitable materials can be used for these components; for example, POM; and the material used can include PTFE, Silicon or PFPE (Perfluoropolyether Modifier) added in. Preferably, the material selected provides a very rigid spring seat. Glass fiber and rare earth additives can be included in varying amounts, preferably in an amount that does not exceed 50%. As noted above, for the isolator 20, any suitable vibration dampening material can be used; for example, a TPE, MPE, or TPU. As a more specific example, Alcryn™ Melt-Processible rubber is available from the Advanced Polymer Alloys division of Ferro™. This MPE rubber can operate in a range of −70° C. to +130° C. and has a hardness of 40 to 90 Shore A. For a spring seat made from glass filled nylon, the retention of an isolator made from this material against the spring seat will be primarily through the retention features described above, as it does not bond well to the nylon. As another specific example, Ferro's APA DuraGrip™ TPE line provides a high quality rubber-like material with a temperature range of −40° C. to +70° C. and a hardness can range between 20 and 90 Shore A. An advantage of the DuraGrip materials (such as DuraGrip 6100) is that it can form a strong bond with the glass filled nylon. Furthermore, the material can be recycled and reused again as a TPE.

As noted above, in at least some embodiments, the isolator can be molded to the spring seat to form a composite single component that operates as (1) the lower bearing housing, (2) the spring seat, and (3) the isolator. This can be accomplished in various ways. For example, two shot or the over molding of TPE or other isolator material onto a rigid spring seat substrate can result in a visually appealing assembly. It can also provide a savings in terms of labor and floor space. The two shot molding of the isolator and spring seat can be carried out in the same machinery with the spring seat being at least partially molded first followed by the isolator material being added and molded to the spring seat that is still in the mold. This can be done using an injection press having two runner systems which can allow the use of two different resins. One can be the more rigid material such as glass filled nylon noted above and the other the dampening material used for the isolator. The injection machine can have two injection units that fill the two runners and allow the different materials to flow into the different cavities. Once the cavities fill the mold rotates 180°, the mold closes and the cycle begins again. The hot substrate is usually in a semi-solid state. This permits melt and chemical bonding, resulting in a permanent connection of the isolator to the spring seat. Co-injection molding is an alternative process that can be used. When co-molding, the two materials can be injected simultaneously with the substrate material for the spring seat moving to the outer mold surface. This approach can provide a good resulting bond of the materials.

When over molding the isolator dampening material to the more rigid spring seat (and lower bearing member), the interconnection of two components can be achieved in several fashions. One is the mechanical interlocking noted above wherein the spring seat is formed with a mechanical retention feature such that the isolator material flows into or around that retention feature and forms a complementary retention feature. This gives a mechanical connection. The grooves, undercuts, etc. that are used should be strategically placed so the integrity of the rigid spring seat is not compromised. This can be confirmed by the use of FEA (finite element analysis). As long as the overmolded polymer does not require a high processing temperature as compared to the base material of the spring seat, any TPE can be used. This mechanical attachment locks the isolator against movement and escape from the spring contact in the strut assembly. In this regard, the more locking features that can be added the better the solution assuming the rigidity is not significantly decreased. A second way in which the molding process can provide a suitable interconnection of the two components is by melt or chemical adhesion between the base material and the isolator material. This provides a permanent bond between the components. For this, the two materials used should have a similar melting point and chemical structure that permits the two parts to solvate at the mating surfaces and form a bond to some degree. This bond will vary based on the materials that are chosen, but should not be greater than the shear strength of the weaker material. In some embodiments, this bond will be sufficient to permanently connect the two components together without the need for grooves or other mechanical retention features discussed above.

The foregoing description is of several embodiments of a ring bearing assembly having an integrated spring seat and isolator as it might be utilized in an automotive strut assembly for an automobile. However, it will be appreciated by those skilled in the art that the disclosed bearing arrangement is useful in other types of struts and in other bearing applications which involve a suspension spring or other annular supporting structure. Thus, it is to be understood that the invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, although the lower annular member 16 and spring seat 18 are depicted together as being a unitary one-piece component, it will be appreciated that a separate plastic or metal spring seat can be used that is integrally attached to the isolator using any of the approaches described above. The separate spring seat/isolator functions as a load distributor and for this purpose can be constructed to have a high stiffness relative to the lower bearing member and thus can be used to more equally distribute the load of the coil spring to the plastic base. In this regard, some coil springs do not completely surround the spring seat surface. For example, a coil spring may only engage a portion of the entire circumference of the spring seat surface, which may lead to uneven loading of the plastic base. To improve the load distribution the isolator can have a helical form that follows the spring coil profile. This and all such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A ring bearing assembly for use with a suspension spring in an automotive suspension strut, comprising:
a bearing having upper and lower annular bearing members and having a pair of bearing surfaces disposed in confronting alignment with each other;
a spring seat disposed below said bearing surfaces and having a contour shaped to receive an upper end of a suspension spring; and
an isolator positioned within said spring seat such that said isolator fits between said spring seat and the suspension spring;
wherein said spring seat has an exterior surface having a mechanical retention feature, and wherein said isolator has an interior surface in contact with said exterior surface of said spring seat, said isolator including a complementary retention feature at its interior surface that mates with said mechanical retention feature to thereby help maintain said isolator in position in said spring seat.

2. A ring bearing assembly as defined in claim 1, wherein said spring seat and lower annular bearing member together comprise a unitary one-piece component.

3. A ring bearing assembly as defined in claim 2, wherein said one-piece component comprises glass-filled nylon.

4. A ring bearing assembly as defined in claim 1, wherein said isolator comprises a thermoplastic elastomer (TPE), melt processible elastomer (MPE), or thermoplastic polyurethane (TPU).

5. A ring bearing assembly as defined in claim 1, wherein said isolator is bonded by its interior surface to the exterior surface of said spring seat, whereby said isolator is attached to said spring seat by both a bond and said retention features.

6. A ring bearing assembly as defined in claim 1, wherein said isolator and spring seat are molded together such that they form a permanently integrated component.

7. A ring bearing assembly as defined in claim 1, wherein said mechanical retention feature comprises one or more grooves in said spring seat.

8. A ring bearing assembly as defined in claim 7, wherein said spring seat includes a radially-extending flange and an axially-extending hub, and wherein said one or more grooves comprises an annular groove formed in said hub.

9. A ring bearing assembly as defined in claim 8, wherein said one or more grooves includes a second annular groove formed in said flange.

10. A ring bearing assembly as defined in claim 1, wherein said mechanical retention feature comprises one or more protrusions on said spring seat with said complementary retention feature of said isolator comprising a groove located at said interior surface of said isolator.

11. A ring bearing assembly for use with a suspension spring in an automotive suspension strut, comprising:
a bearing having upper and lower annular bearing members and having a pair of bearing surfaces disposed in confronting alignment with each other;
said lower annular bearing member having a radially-extending flange and axially-extending hub located radially-inwardly of the flange such that said hub and flange together define an integral spring seat having a contour shaped to receive an upper end of a suspension spring; and
an isolator comprising TPE, MPE, or TPU molded to said spring seat and extending at least partially along an exterior surface of said hub and said flange, whereby in use said isolator is positioned between said spring seat and the suspension spring;
wherein at least one of said hub and said flange includes a mechanical retention feature that is mated to a complementary retention feature of said isolator, said complementary retention feature having a molded shape defined by said mechanical retention feature, whereby said isolator is both molded to and mechanically retained by said spring seat.

12. A ring bearing assembly as defined in claim 11, wherein said lower annular bearing member comprises glass-filled nylon.

13. A ring bearing assembly as defined in claim 11, wherein said mechanical retention feature comprises one or more grooves in said spring seat.

14. A ring bearing assembly as defined in claim 13, wherein said one or more grooves comprises an annular groove formed in said hub.

15. A ring bearing assembly as defined in claim 14, wherein said one or more grooves includes a second annular groove formed in said flange.

16. A ring bearing assembly as defined in claim 11, wherein said mechanical retention feature comprises one or more protrusions on said spring seat with said complementary retention feature of said isolator comprising a groove located at an interior surface of said isolator.

17. A ring bearing assembly as defined in claim 11, wherein said bearing further comprises a plurality of roller elements disposed between said bearing surfaces.

18. A ring bearing assembly as defined in claim 11, wherein said bearing surfaces comprise facing surfaces of a pair of bearing rings, with each of said bearing rings being disposed in a channel in a respective one of said annular bearing members.

19. A ring bearing assembly for use with a suspension spring in an automotive suspension strut, comprising:
a bearing having upper and lower annular bearing members and confronting bearing surfaces that permit relative rotation between said upper and lower bearing members;
a spring seat disposed below said bearing surfaces and having a contour shaped to receive an upper end of a suspension spring; and
an isolator molded in place against said spring seat such that said isolator is permanently bonded to said spring seat in a position such that, when assembled with the suspension spring in a strut assembly, the isolator is located between said spring seat and the suspension spring.

20. A ring bearing assembly as defined in claim 19, wherein said isolator is overmolded or co-molded to said spring seat.
